(19) United States
(12) Patent Application Publication
(10) Pub. No.: US 2009/0142571 A1
(43) Pub. Date: Jun. 4, 2009

(54) Fiberglass and urethane inclusive siding panels, and/or method of making the same

(75) Inventor: William H. Crostic, JR., Simpsonville, SC (US)

Correspondence Address: DORITY & MANNING, P.A., POST OFFICE BOX 1449, GREENVILLE, SC, 29602-1449, US

(73) Assignee: Guardian Building Products, Inc., Greer, SC (US)

(21) Appl. No.: 11/987,410

(22) Filed: Nov. 29, 2007

(51) Int. Cl. B32B 5/02; E04B 2/00

(52) U.S. Cl. 428/292.1; 156/71

(57) ABSTRACT

Certain example embodiments of this invention relate to composite siding panels, and/or methods of making the same. In certain example embodiments, a method of making a siding panel is provided. A first cover is provided. A fiberglass based substrate is provided. Urethane is applied to at least some of the fiberglass before at least some of the fiberglass reaches the first cover. The fiberglass is provided so as to be supported by the first cover. A second cover is provided so that the fiberglass is provided between at least the first and second covers. The fiberglass, wetted with the urethane, is flattened and/or densified between at least the first and second covers to form at least part of the siding panel. The siding panel may have a specific gravity of between about 0.5 and 1.2. The compressed siding panel may comprise from about 5-30% urethane by weight and from about 75-95% fiberglass by weight.

### FIELD OF THE INVENTION

Certain example embodiments of this invention relate to composite siding panels, and/or methods of making the same. More particularly, certain example embodiments relate to siding panels comprising a substrate including fiberglass and a polymer-based coating (e.g., urethane) that has been wrapped between one or more covers and flattened and compressed to create the siding panel at a suitable density and thermal expansion coefficient.

### BACKGROUND AND SUMMARY OF EXAMPLE EMBODIMENTS OF THE INVENTION

For years, wood was the traditional siding product for those interested in a lower cost alternative to brick, as well as achieving a traditional Cape Cod look for their home or other structure. The known shortcomings of wood include, for example, susceptibility to insect attack, moisture sensitivity, microbial attack or rot, and warping, cupping, and cracking. Painting generally was an absolute necessity, and it had to be done with a high degree of regularity. As a result of the maintenance associated with wood, a number of alternatives were developed.

Initially, an aluminum siding alternative was developed. An aluminum sheet was formed in the shape of a siding board or panel and then hung on the house. The installation was quite different than wood and required a learning curve. The aluminum product was coated with a UV fade resistant coating, which typically had a 20-year guaranty. Unfortunately, in addition to this learning curve, there were certain drawbacks with using aluminum siding. Some of the pitfalls of aluminum siding include, for example, chalking of the coating, scratches, and poor impact resistance against denting.

As the plastics industry—and more specifically, the PVC industry—developed, it became possible to make a product that could compete with aluminum. This product advantageously provided substantially homogeneous color throughout the siding, far better impact resistance, and unique wood-like embossed finishes. Although UV resistance on the early PVC siding products was very poor, today, PVC siding provides fade resistant performance for about 25 years. PVC siding remains the lowest cost, highest volume siding product in the siding industry.

Although there have been improvements to PVC siding products over the years, certain drawbacks still remain. For example, PVC siding products still do not possess quite the appearance and charm of a natural wood product. Also, once a color is chosen, the homeowner is unable to later change the color of the house. In response, natural wood suppliers have worked on a product that would help solve some of the shortcomings associated with wood by using technology developed for plywood and oriented strand board (OSB). In particular, a medium- and high-density hard-board product that provided the appearance of wood eventually was developed. Although this product was pre-coated, it still allowed the homeowner to later change the color with paint. While this product was an improvement over wood, it still had some of the traditional problems associated with wood, such as, for example, susceptibility to moisture and microbial attack.

The latest entry into the siding industry is fiber cement. This product nails up like wood. It is pre-primered and is generally painted. It has solved all of the wood performance issues and provides an appearance acceptably close to wood. However, one of the fiber cement product's biggest weaknesses relates to the inclusion of silica in the corresponding products. More particularly, when sawing the product, appropriate respirators must be worn to prevent inhalation of the dust. This has prevented several major distributors from selling the product. In addition to this drawback, the product is very heavy and will break under its own weight. However, fiber cement market share has continued to grow.

Thus, it will be appreciated that there is a need in the art for an improved siding product and/or a method of making the same. It also will be appreciated that there is a need in the art for a siding product and/or a method of making the same that overcomes one or more of these and/or other disadvantages associated with traditional wood siding and/or the later-developed alternatives to wood siding.

In certain example embodiments of this invention, a siding panel is provided. First and second covers are provided. A fiberglass based substrate is provided between at least the first and second covers. At least some fibers in the fiberglass based substrate are opened to increase surface area of the fiberglass based substrate. Urethane is provided, directly or indirectly, to and/or in the fiberglass based substrate. The second cover is provided over the urethane coating and/or the fiberglass based substrate. The siding panel comprises from about 5-30% urethane by weight and from about 75-95% fiberglass by weight. The siding panel is compressed so as to have a specific gravity of between about 0.5 and 1.2.

In certain example embodiments, a method of making a siding panel is provided. A first cover is provided. A fiberglass based substrate is provided. Urethane is applied to at least some of the fiberglass before at least some of the fiberglass reaches the first cover. The fiberglass is provided so as to be supported by the first cover. A second cover is provided so that the fiberglass is provided between at least the first and second covers. The fiberglass, wetted with the urethane, is flattened and/or densified between at least the first and second covers to form at least part of the siding panel. The siding panel may have a specific gravity of between about 0.5 and 1.2. The compressed siding panel may comprise from about 5-30% urethane by weight and from about 75-95% fiberglass by weight.

In certain example embodiments, a siding panel is provided. A first cover is provided., A fiberglass based substrate is supported, directly or indirectly, by the first cover, with the siding panel including from about 75-95% fiberglass by weight. A polymer-based material is provided to and/or in the fiberglass substrate, with the siding panel including from about 5-30% polymer-based material by weight. A second cover is provided over the polymer-based material and/or the fiberglass based substrate. The siding panel is compressed so as to have a specific gravity of between about 0.5 and 1.2.

In certain example embodiments, a method of making a siding panel is provided. A first cover is provided. Fiberglass is provided at a pre-compression thickness, with the fiberglass to be supported, directly or indirectly, by the first cover. A polymer-based material in liquid or foam form is applied, directly or indirectly, to and/or in the fiberglass. A second cover is provided over the fiberglass that is wetted with the polymer-based material. The fiberglass wetted with the polymer-based material is flattened and/or densified so as to form a compressed siding panel at a compressed thickness less than the pre-compression thickness and having a specific gravity of between about 0.5 and 1.2. The compressed siding panel comprises from about 5-30% polymer-based coating by weight and from about 75-95% fiberglass by weight.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a simplified illustrative system view of how the components of a siding panel may be provided, in accordance with an example embodiment;

FIG. 2 is a cross-sectional view of a compressed siding panel arranged in accordance with an example embodiment; and

FIG. 3 is an illustrative flowchart showing a process for making a siding panel in accordance with an example embodiment.

### DETAILED DESCRIPTION OF EXAMPLE EMBODIMENTS OF THE INVENTION

In certain example embodiments, a method of making a siding panel (to be used as siding on a single family home, townhouse, or the like) is provided. A first cover is provided. A fiberglass based substrate is provided. Urethane is applied to at least some of the fiberglass before at least some of the fiberglass reaches the first cover. The fiberglass is provided so as to be supported by the first cover. A second cover is provided so that the fiberglass is provided between at least the first and second covers. The fiberglass, wetted with the urethane, is flattened and/or densified between at least the first and second covers to form at least part of the siding panel. The siding panel may have a specific gravity of between about 0.5 and 1.2. The compressed siding panel may comprise from about 5-30% urethane by weight and from about 75-95% fiberglass by weight. In certain example embodiments, a siding panel is provided. A first cover is provided. Fiberglass is supported, directly or indirectly, by the first cover, with the siding panel including from about 75-95% fiberglass by weight. A polymer-based coating is provided, with the siding panel including from about 5-30% polymer-based coating by weight. A second cover is provided over the polymer-based coating and/or the fiberglass. The siding panel is compressed so as to have a specific gravity of between about 0.5 and 1.2.

The siding products of certain example embodiments advantageously may be provided at a lighter weight and at a greater level of abuse resistance then fiber cement. Also, the siding products of certain example embodiments advantageously may have a coefficient of thermal expansion sufficiently low to allow such siding products to be nailed to the house. The coefficient of thermal expansion is a measure of the change of dimension caused by temperature change. For example, the thermal expansion coefficients of completely dry wood are positive in all directions (e.g., wood expands on heating and contracts on cooling). The thermal expansion coefficient of ovendry wood parallel to the grain appears to be independent of specific gravity (e.g., the relative density, or ratio, of a material to the density of water) and species; however, the thermal expansion coefficients across the grain (radial and tangential) are proportional to wood specific gravity. These coefficients range from about 5 to more than 10 times greater than the parallel-to-grain coefficients. The radial and tangential thermal expansion coefficients for ovendry wood, αᵣ and αₜ, respectively, can be approximated by the following equations, over an ovendry specific gravity range of about 0.1 to 0.8:

αᵣ=(32.4 G+9.9)×10⁻⁶ per K

αᵣ=(18 G+5.5)×10⁻⁶ per ° F.

αₜ=(32.4 G+18.4)×10⁻⁶ per K

αₜ=(18 G+10.2)×10⁻⁶ per ° F.

Thermal expansion coefficients typically are considered independent of temperature over the temperature range of about 51.1° C. to 54.4° C. (about 60° F. to 130° F.).

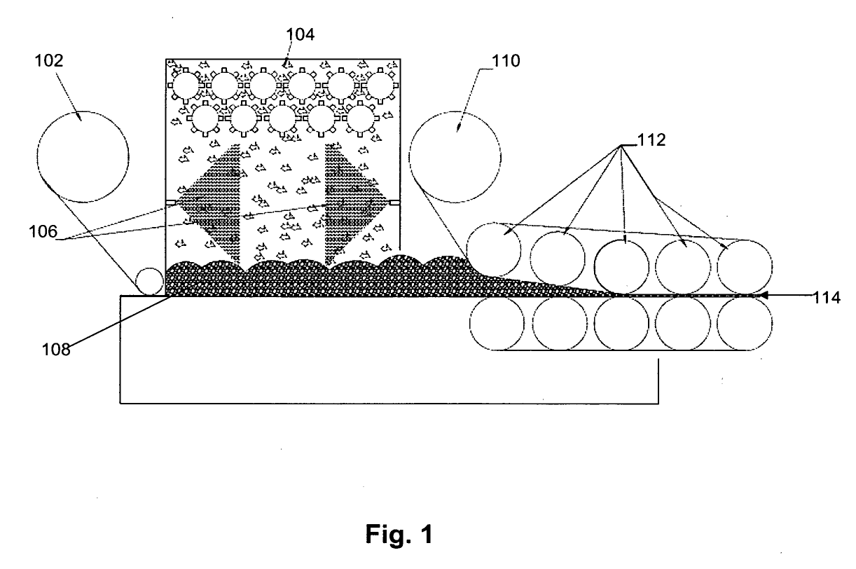

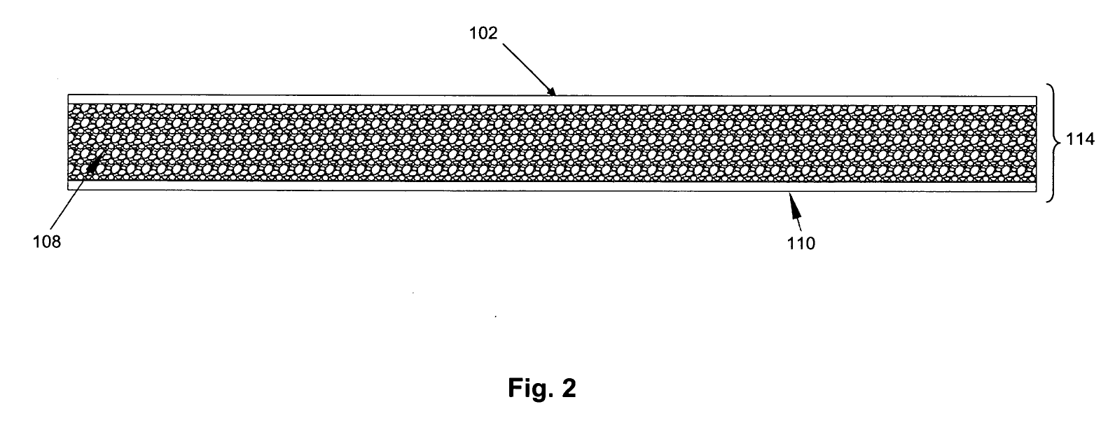

Referring now more particularly to the drawings, FIG. 1 is a simplified illustrative system view of how the components of a siding panel may be provided, in accordance with an example embodiment, and FIG. 2 is a cross-sectional view of a compressed siding panel arranged in accordance with an example embodiment. Blown wool and/or loose fill fiberglass 104, e.g., of the type commercially available from Guardian, are used to create the main substrate of the siding. The fibers in the fiberglass 104 may be opened to increase the surface area of the substrate. The main substrate to be compressed is created by providing blown wool and/or loose fill fiberglass 104 and coating the fiberglass 104 with a polymer-based (e.g., urethane) coating 106. In certain example embodiments, the polymer-based coating 106 may be inserted into the fiberglass 104 (e.g., misted, sprayed, or otherwise provided to and/or in the fiberglass 104, as it is falling to form the compressable main substrate 108 on the first cover 102). Alternatively, or in addition, the polymer-based coating 106 may be provided on one or both major surfaces of a fiberglass substrate. The polymer-based coating 106 may be applied, e.g., in liquid or foam form, for example, via misting, spraying, and/or any other suitable technique. Thus, the polymer-based coating 106 may substantially permeate the compressable main substrate 108, which is a fiberglass based substrate. In certain example embodiments, the polymer-based coating 106 may help serve as a binder for at least some of the glass fibers in the compressable main substrate 108. Thus, for example, in FIG. 2, the polymer-based coating 106 is shown as at least partially permeating the fiberglass substrate 104. In certain example embodiments, the fiberglass substrate 104 is wetted with the polymer-based material prior to compression.

In certain example embodiments, an adhesive (e.g., an adhesive glue, not shown) may be applied to help the polymer-based coating 106, the fiberglass 104, and/or the first and/or second covers 102, 110 bond together. The fibers (which may be pre-coated, partially coated, e.g., on one side, or not coated) are deposited on a first cover 102, which may be a thin film or paper surface (e.g., Kraft paper) at a desired pre-compression thickness. In a case where the fibers are not coated to a desired level (e.g., only partially coated or not coated at all), the polymer-based coating 106 may be applied (or re-applied) to the fiberglass 104 while it is on the first cover 102. A second cover 110 is applied to a top surface of the coated fibers.

This product enters a series of compression rollers 112, belts, and/or the like to suitably compress the product into its end product 114. The compressable main substrate 108 will be compressed between the two film or paper layers 102, 110 to form the compressed product 114 such that it has a specific gravity (e.g., relative density of the material to the density of water) of between about 0.5 and 1.2. More preferably, the final product will have a density measured by a specific gravity of about 0.6-0.9, and even more preferably about 0.8. By way of comparison, wood as a whole typically is regarded as having a specific gravity of about 0.5, with an ovendry specific gravity range of about 0.1 to 0.8. For example, dry yellow southern pine has a specific gravity of about 0.72, dry California redwood has a specific gravity of about 0.45, dry California spruce has a specific gravity of about 0.45, Douglas fir has a specific gravity of about 0.53, a red cedar has a specific gravity of about 0.38. In certain example embodiments, the wood may be compressed to a density (e.g., a relative density and/or specific gravity) similar to that of a particular wood and/or to a particular value (e.g., within one of the preferable ranges noted above).

The density (e.g., specific gravity or relative density of the material as compared to water) and/or coefficient of thermal expansion may be controlled at least in part by the compressive forces applied during the one or more compression steps described above. It will be appreciated that some porosity is needed to allow the siding to be affixed to the house (e.g., to allow nails to be hammered, screws to be drilled, etc., through the siding, etc.). It also will be appreciated that the compression percentage effects the expansion and contraction of the siding, and is relevant to reducing warping (e.g., over time and/or in response to changing weather, exposure to elements, material variations, and/or other conditions). This is because, in part, the thermal expansion coefficients across the “grain” (radial and tangential) are proportional to specific gravity, similar to the case of wood described above. Thus, it will be appreciated that the amount of compressive force(s) applied during the compression step(s) may be customized to reduce the chances of the final siding product being produced with too much or too little porosity.

By way of example and without limitation, siding often comes in widths of 4 feet. Also by way of example and without limitation, the thickness of the finished siding product may be from about 0.25 to 0.5 inches. It will be appreciated that any sizes and/or dimensions may be provided as final thicknesses and/or dimensions, e.g., as desired for use with the applicable industries (e.g., residential housing projects, commercial construction, and/or the like).

When finished, the composition of the finished siding product may include from about 5-30% polymer (e.g., a flame retardant (FR) grade polyurethane thermoset resin) by weight, or more preferably from about 5-25% polymer by weight, and still more preferably from about 10-20% polymer by weight. The finished siding product may include from about 75-95% fiberglass by weight, and more preferably from about 80-90% fiberglass by weight.

The product optionally may be pre-colored with a UV fade resistant and/or abuse resistant film. Additionally, or in the alternative, it may be pre-primered similar to the conventional fiber cement product described above. A sequential die process also may be used in connection with certain example embodiments, e.g., to color the product in a way suitable for its end use. In certain example embodiments, rollers may be used to emboss the product, for example, to provide a desired aesthetic pattern (e.g., a particular wood grain pattern) for one or both sides of the siding product. In certain example embodiments, the two major surfaces of the panels may be differently patterned. These steps may be performed on the first and/or second covers 102, 110, directly or indirectly, before, during, and/or after assembly of the products. Also, the embossing may be concomitant with one or more of the compression steps (e.g., the same rollers as those used for compression may be used for embossing, embossing rollers may provide some compression of the product, etc.). Thus, by way of example and without limitation, the first and/or second cover may be pre-colored with a UV fade resistant film before being applied over the fiberglass substrate 104, and the entire product may be embossed (e.g., via a second roller-based process) after compression. Of course, it will be appreciated that these steps may be applied in any suitable combination and at any time during the siding manufacturing process.

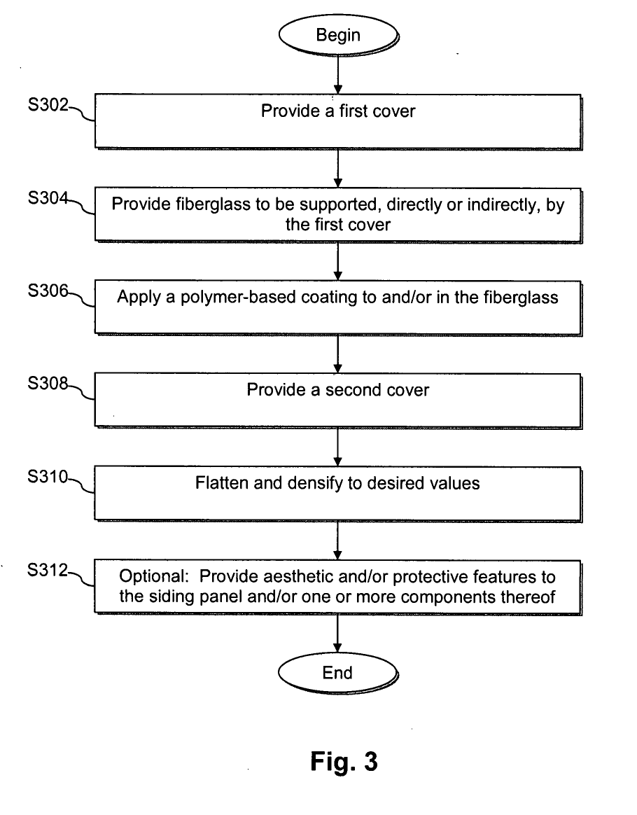

FIG. 3 is an illustrative flowchart showing a process for making a siding panel in accordance with an example embodiment. A first cover is provided in step S302. As noted above, the cover may be a thin film or paper product (e.g., Kraft paper). Fiberglass is provided in step S304 such that it is supported, either directly or indirectly, by the first cover. The fibers are provided at a pre-compression thickness, which ultimately will be reduced during one or more compression steps set forth below. A polymer-based coating (e.g., of or including urethane) is applied, for example, in liquid or foam form via misting, spraying, and/or the like, to the fiberglass in step S306. This may help serve as a binder for the fibers and/or help to bind the fiberglass substrate to a second cover provided, directly or indirectly, on the fiberglass and/or the polymer-based coating in step S308. Thus, in certain example embodiments, polyurethane and/or optional additional adhesives (e.g., glues) may help bond the cover(s) to the rest of the article.

The compressable stack of the first and second covers surrounding the fiberglass substrate and the polymer-based coating is flattened and/or densified in step S310. This may be accomplished by using compression rollers, belts, and/or the like, which may be tuned to provide the ultimate siding product at a suitable density, thickness, and/or thermal expansion coefficient. Thus, pressure supplied by the compression (e.g., via the compression rollers) may help determine the density, thickness, and/or thermal expansion coefficient of the finished siding panel. Accordingly, the fiberglass, wetted with the urethane, is flattened and/or densified between at least the first and second covers to form at least part of the siding panel.

Aesthetic and/or protective features may be applied to the siding panel and/or one or more components thereof in optional step S312. Aesthetic features may be provided by, for example, embossing a pattern (e.g., a grain pattern to mimic a particular type of wood, etc.); painting, inking, and/or dying; etc. Protective features may be provided by, for example, providing a UV protective coating, one or more primers and/or pre-primers, etc.

It will be appreciated that although the techniques described herein are described in relation to providing siding panels for particular projects, the present invention is not limited thereto. Siding panels may be provided for, for example, residential and/or commercial projects. The techniques of certain example embodiments also may be used to produce sheets other than siding panels. It will be appreciated that certain example embodiments may provide fiberglass that is at least blown insulation, blown wool insulation, virgin fiberglass, and/or the like. Also, the features, aspects, advantages, and example embodiments described herein may be combined to realize yet further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A siding panel comprising:
first and second covers;
a fiberglass based substrate provided between at least the first and second covers, at least some fibers of the fiberglass based substrate being opened to increase surface area of the substrate; and
urethane provided to and/or in the fiberglass based substrate;
wherein the siding panel comprises from about 5-30% urethane by weight and from about 75-95% fiberglass by weight, and
wherein the siding panel is compressed so as to have a specific gravity of from about 0.5 to 1.2.

2. The siding panel of claim 1, wherein the urethane at least partially binds the fiberglass based substrate to the first and/or second cover.

3. The siding panel of claim 1, further comprising an adhesive, the adhesive at least partially bonding the fiberglass based substrate to the first and/or second covers.

4. The siding panel of claim 1, further comprising a UV protective coating.

5. The siding panel of claim 1, wherein the urethane is a flame retardant grade polyurethane thermoset inclusive resin.

6. The siding panel of claim 1, wherein the siding panel is compressed so as to have a specific gravity of from about 0.6 to 0.9.

7. The siding panel of claim 1, wherein the siding panel is compressed so as to have a specific gravity of about 0.8.

8. The siding panel of claim 1, wherein the siding panel comprises from about 5-25% urethane by weight.

9. The siding panel of claim 1, wherein the siding panel comprises from about 10-20% urethane by weight.

10. The siding panel of claim 1, wherein the siding panel comprises from about 80-90% fiberglass by weight.

11. The siding panel of claim 1, wherein the first and second covers comprise paper.

12. The siding panel of claim 1, wherein the fiberglass based substrate at least initially is provided as blown wool insulation.

13. A method of making a siding panel, the method comprising:
providing a first cover;
providing fiberglass;
applying urethane to at least some of the fiberglass before at least some of the fiberglass reaches the first cover;
providing the fiberglass so as to be supported by the first cover;
providing a second cover, so that the fiberglass is provided between at least the first and second covers; and
flattening and/or densifying the fiberglass, wetted with the urethane, between at least the first and second covers to form at least part of the siding panel.

14. The method of claim 13, wherein the siding panel has a specific gravity of from about 0.5 and 1.2.

15. The method of claim 13, wherein the compressed siding panel comprises from about 5-30% urethane and from about 75-95% fiberglass.

16. The method of claim 13, further comprising at least partially binding the fiberglass to the cover via the urethane.

17. The method of claim 13, further comprising applying an adhesive so as to at least partially bond the fiberglass to another cover.

18. The method of claim 13, embossing a pattern on one or both major surfaces of the siding panel.

19. The method of claim 13, further comprising applying a UV protective coating to the siding panel.

20. The method of claim 13, wherein the fiberglass based substrate is compressed so as to have a specific gravity of from about 0.6-0.9.

21. The method of claim 13, wherein the fiberglass is compressed so as to have a specific gravity of about 0.8.

22. The method of claim 13, wherein the siding panel comprises from about 5-25% urethane by weight.

23. The method of claim 13, wherein the siding panel comprises from about 10-20% urethane by weight.

24. The method of claim 13, wherein the siding panel comprises from about 80-90% fiberglass by weight.

25. The method of claim 13, wherein the fiberglass at least initially is provided as blown wool insulation.

26. A siding panel, comprising:
a first cover;
a fiberglass based substrate including from about 75-95% fiberglass by weight; and
a polymer-based material provided to and/or in the fiberglass based substrate, the siding panel including from about 5-30% polymer-based material by weight; and
a second cover provided over the polymer-based material and/or the fiberglass substrate,
wherein fiberglass based substrate including the polymer-based material is compressed so as to have a specific gravity of from about 0.5 and 1.2.
